(19) United States
(12) Patent Application Publication
(10) Pub. No.: US 2025/0156656 A1
(43) Pub. Date: May 15, 2025

(54) SPEECH TRANSLATION METHOD, APPARATUS, ELECTRONIC DEVICE, AND MEDIUM

(71) Applicants: Lemon Inc., Grand Cayman (KY); Beijing Youzhuju Network Technology Co., Ltd., Pinggu District (CN)

(72) Inventors: Zhichao Huang, Hong Kong (HK); Rong Ye, Beijing (CN); Yu Ting Ko, Hong Kong (HK); Qianqian Dong, Beijing (CN); Shanbo Cheng, Singapore (SG); Mingxuan Wang, Beijing (CN); Hang Li, Beijing (CN)

(21) Appl. No.: 18/941,556

(22) Filed: Nov. 8, 2024

(30) Foreign Application Priority Data
Nov. 10, 2023 (CN) 202311502894.X

(51) Int. Cl. G06F 40/58; G06F 40/53; G10L 15/04

(52) U.S. Cl. CPC G06F 40/58; G06F 40/53; G10L 15/04

(57) ABSTRACT

Embodiments of the present disclosure relate to a speech translation method, an apparatus, an electronic device, and a medium. The method includes generating a speech representation corresponding to a source-language audio based on the audio. The method also includes obtaining prompt content related to a target language. In addition, the method also includes generating a target-language text corresponding to the audio based on the speech representation and the prompt content.

### CROSS-REFERENCE TO RELATED APPLICATION(S)

This application claims priority to Chinese Application No. 202311502894.X filed on Nov. 10, 2023, the disclosures of which are incorporated herein by reference in their entireties.

### FIELD

The present application relates to the field of computer technologies, and in particular, to a speech translation method, an apparatus, an electronic device, and a medium.

### SUMMARY

Embodiments of the present disclosure provide a speech translation method, an apparatus, an electronic device, and a medium.

According to a first aspect of the present disclosure, a speech translation method is provided. The method includes generating a speech representation corresponding to a source-language audio based on the audio. The method also includes obtaining prompt content related to a target language. In addition, the method also includes generating a target-language text corresponding to the audio based on the speech representation and the prompt content.

According to a second aspect of the present disclosure, a speech translation apparatus is provided. The apparatus includes a speech representation generation module configured to generate a speech representation corresponding to a source-language audio based on the audio. The apparatus also includes a prompt content obtaining module configured to obtain prompt content related to a target language. In addition, the apparatus also includes a target text generation module configured to generate a target-language text corresponding to the audio based on the speech representation and the prompt content.

According to a third aspect of the present disclosure, an electronic device is provided. The electronic device includes a processor and a memory coupled with the processor, where the memory has stored therein instructions that, when executed by the processor, cause the electronic device to perform the method according to the first aspect.

In a fourth aspect of the present disclosure, a computer-readable storage medium is provided. The computer-readable storage medium has stored thereon one or more computer instructions, where the one or more computer instructions are executed by a processor to implement the method according to the first aspect.

The Summary section is intended to introduce a selection of concepts in a simplified form, which will be further described below in the Detailed Description section. The Summary section is not intended to identify key features or essential features of the claimed subject matter, nor is it intended to be used to limit the scope of the claimed subject matter.

### BRIEF DESCRIPTION OF THE DRAWINGS

The above and other features, advantages, and aspects of embodiments of the present disclosure become more apparent with reference to the following detailed description and in conjunction with the accompanying drawings. In the drawings, the same or similar reference numerals denote the same or similar elements, where:

FIG. 1 is a schematic diagram of an example environment in which embodiments of the present disclosure can be implemented;

FIG. 2 is a flowchart of a speech translation method according to an embodiment of the present disclosure;

FIG. 3 is a schematic diagram of a process for generating a target-language text according to an embodiment of the present disclosure;

FIG. 4 is a schematic diagram of a process for processing a long audio according to an embodiment of the present disclosure;

FIG. 5 is a schematic diagram of a process for fine-tuning a speech translation model according to an embodiment of the present disclosure;

FIG. 6 is a schematic diagram of another process for fine-tuning the speech translation model according to an embodiment of the present disclosure;

FIG. 7 is a schematic diagram of still another process for fine-tuning the speech translation model according to an embodiment of the present disclosure;

FIG. 8 is a block diagram of a speech translation apparatus according to some embodiments of the present disclosure; and

FIG. 9 is a block diagram of an electronic device according to some embodiments of the present disclosure.

Throughout the drawings, the same or similar reference numerals denote the same or similar elements.

### DETAILED DESCRIPTION OF EMBODIMENTS

It may be understood that before the technical solution disclosed in each embodiment of the present disclosure is used, the user shall be informed of the type, scope of use, use scenario, and the like of the personal information (for example, speech) involved in the present disclosure in an appropriate manner in accordance with relevant laws and regulations, and the user's authorization shall be obtained.

For example, when a user actively requests, a prompt message is sent to the user, to explicitly prompt the user that the operation requested by the user will need to obtain and use the user's personal information. Therefore, the user can independently choose whether to provide personal information (such as speech) to a software or hardware such as an electronic device, an application, a server, or a storage medium that performs an operation of the technical solution of the present disclosure based on the prompt information. It may be understood that the above notification and user authorization obtaining process are merely illustrative, and do not constitute a limitation on the implementation of the present disclosure. Other methods that meet relevant laws and regulations may also be applied to the implementation of the present disclosure.

It may be understood that the data (including but not limited to the data itself, data acquisition, or data use) involved in this technical solution shall comply with the requirements of corresponding laws, regulations, and relevant provisions.

Speech translation technology is an important innovation that involves speech recognition technology, natural language processing, machine translation, and the like. The speech translation task aims to translate a source-language speech into a target-language text, and is widely applied to various scenarios such as meeting speech translation, video caption translation, and augmented reality translation.

With the development of globalization, speech translation plays a critical role in communication, business, and cultural exchange. By translating the source-language speech into the target-language text, communication between different languages is facilitated, and international cooperation is enhanced. In the digital age, the importance of speech translation is constantly highlighted, providing people with broader communication opportunities.

Embodiments of the present disclosure are described in more detail below with reference to the accompanying drawings. Although some embodiments of the present disclosure are shown in the drawings, it should be understood that the present disclosure may be implemented in various forms and should not be construed as being limited to the embodiments set forth herein. Rather, these embodiments are provided for a more thorough and complete understanding of the present disclosure. It should be understood that the drawings and embodiments of the present disclosure are only for exemplary purposes, and are not intended to limit the scope of protection of the present disclosure.

In the description of the embodiments of the present disclosure, the term “include/comprise” and similar terms should be understood as an open inclusion, that is, “include/comprise but not limited to”. The term “based on” should be understood as “at least partially based on”. The term “an embodiment” or “the embodiment” should be understood as “at least one embodiment”. The terms “first”, “second”, and the like may refer to different or the same objects unless the context clearly indicates otherwise. Other definitions, either explicit or implicit, may be included below.

The speech translation task aims to convert a source-language audio into a target-language text, for example, converting an English audio into a corresponding Chinese text. An existing speech translation task usually performs speech recognition first and then performs machine translation. For example, an English audio is first subjected to speech recognition to obtain a corresponding English text, and then the English text is subjected to machine translation to generate a corresponding Chinese text. However, the speech translation task is divided into two cascaded subtasks, resulting in errors in the speech recognition task being accumulated in the machine translation task, which affects the final effect of the speech translation task.

To solve the above problem, the embodiments of the present disclosure provide a speech translation solution. The solution may generate a speech representation corresponding to a source-language audio from the source-language audio, then obtain prompt content related to a target language, and finally generate a target-language text corresponding to the source-language audio based on the speech representation and the prompt content. Therefore, by generating a speech representation from the source-language audio and combining the prompt content, a corresponding target-language text is generated, thereby avoiding problems such as error accumulation and error propagation in cascaded tasks and stiffness of speech recognition, improving fluency and readability of a speech translation result, and further improving user experience during speech translation.

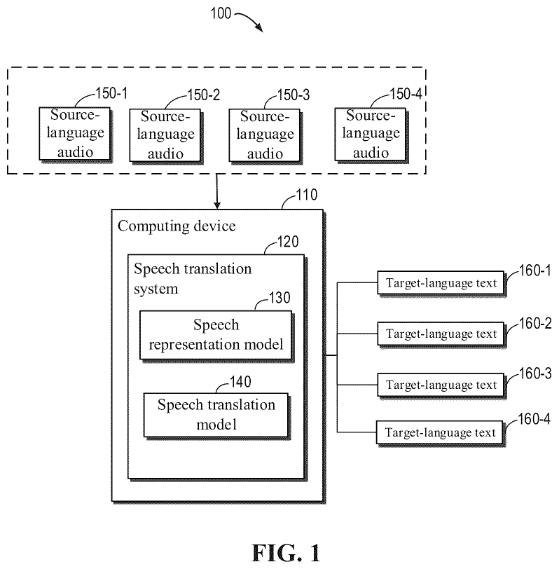

FIG. 1 is a schematic diagram of an example environment 100 in which the method according to the embodiments of the present disclosure can be implemented. As shown in FIG. 1, the example environment 100 may include a computing device 110, which may be a user terminal, a mobile device, a computer, etc., and may also be a computing system, a single server, a distributed server, or a cloud-based server. The computing device 110 may receive a source-language audio 150-1, a source-language audio 150-2, a source-language audio 150-3, and a source-language audio 150-4 (collectively or individually referred to as a source-language audio 150). The source-language audio 150 may be understood as a speech for a period of time, for example, a voice of a user speaking, which contains meaningful content and may usually be recorded in text. It may be understood that the environment 100 may include more or fewer audios.

In the computing device 110, a speech translation system 120 may also be included. For example, the speech translation system 120 is deployed in the computing device 110. The speech translation system 120 may be used to generate a translation result of the source-language audio 150 based on the source-language audio 150, that is, a text 160-1 in a target language, a text 160-2 in the target language, a text 160-3 in the target language, and a text 160-4 in the target language (collectively or individually referred to as a text 160 in the target language). In some embodiments, the speech translation system 120 may be obtained by pre-training a generative pre-trained transformer model by using a large-scale document-level multilingual document and fine-tuning the model by using a multitask such as a speech recognition task, a machine translation task, and a speech translation task.

With reference to FIG. 1, the speech translation system 120 includes a speech representation model 130. In some embodiments, the speech representation model 130 may be a speech model pre-trained by using a weak supervision method, and may generate a speech representation of the source-language audio 150. In addition, in some embodiments, the speech representation model 130 may be a speech model trained by using an unsupervised method, which is not limited in the present disclosure.

The speech representation model 130 may be used to generate the speech representation of the source-language audio 150, and the speech translation model 140 may process the speech representation. When processing the speech representation, corresponding prompt content needs to be obtained. In some embodiments, the prompt content may be “Please convert the source-language audio into a target-language text”, and the speech translation model 140 may generate the corresponding text 160 in the target language based on the prompt content and the speech representation.

It should be understood that the architecture and functions in the example environment 100 are described for illustrative purposes only, without suggesting any limitation to the scope of the present disclosure. The embodiments of the present disclosure may also be applied to other environments with different structures and/or functions.

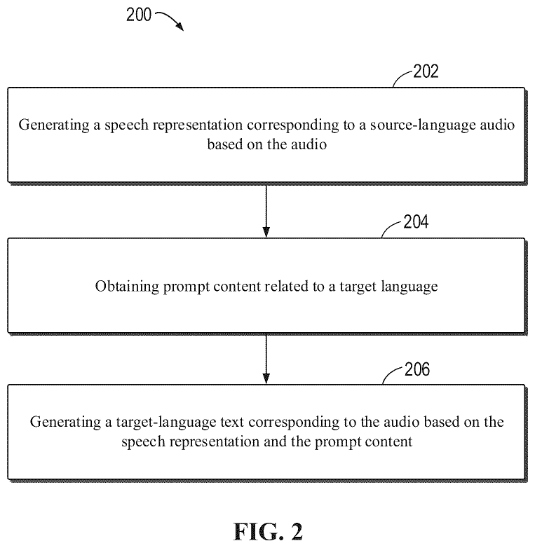

The processes according to the embodiments of the present disclosure are described in detail below with reference to FIG. 2 to FIG. 9. For the purpose of understanding, the specific data mentioned in the descriptions below are all exemplary and are not used to limit the scope of protection of the present disclosure. It may be understood that the embodiments described below may further include additional actions that are not shown and/or may omit the shown actions, and the scope of the present disclosure is not limited in this respect.

FIG. 2 is a flowchart of a speech translation method 200 according to an embodiment of the present disclosure. At block 202, a speech representation corresponding to a source-language audio is generated based on the audio. For example, with reference to FIG. 1, the speech translation system 120 may obtain a source-language audio 150-1 and a source-language audio 150-2, or obtain a source-language audio 150-1, a source-language audio 150-2, a source-language audio 150-3, and a source-language audio 150-4, and generate a speech representation corresponding to the source-language audio based on the source-language audio.

At block 204, prompt content related to a target language is obtained. For example, with reference to FIG. 1, the prompt content may be used to instruct the speech translation system 120 to perform a speech translation task. In some embodiments, the prompt content may be “Please convert the source-language audio into a text in Chinese” or “convert into a text in English”, etc., to instruct the speech translation system to perform the speech translation task.

At block 206, a target-language text corresponding to the audio is generated based on the speech representation and the prompt content. For example, with reference to FIG. 1, the speech translation system 120 generates a text 160 in a target language corresponding to the source-language audio 150 based on the speech representation and the prompt content.

Therefore, the method 200 according to the embodiments of the present disclosure may perform a speech translation task in an end-to-end manner, and generate a corresponding target-language text from the source-language audio, thereby avoiding error accumulation in cascaded tasks and improving the effect of speech translation.

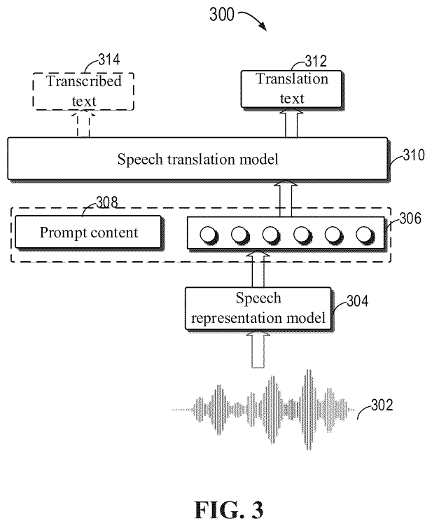

FIG. 3 is a schematic diagram of a process 300 for generating a target-language text according to an embodiment of the present disclosure. First, a source-language audio 302 is obtained. For example, the source-language audio 302 may be an English audio. It should be understood that the English audio is used as the source-language audio only as an example, and the present disclosure does not limit the language type of the source-language audio. Then, a speech representation 306 of the source-language audio 304 is generated by using a speech representation model 304. In some embodiments, the speech representation model 304 may be a speech representation model of an encoder-decoder transformation architecture trained by using weak supervision learning. Many speech models rely on high-quality labeled audio/text data for supervised learning. A model trained in this way can generate good speech recognition results under ideal conditions, but due to the limited number of labeled data, it often cannot generalize well, may encounter difficulties when processing low-quality real-world audio, and usually requires additional speech fine-tuning to prepare for specific use cases. In addition, a large amount of unlabeled audio is used to develop an unsupervised learning speech representation model. A model created in this way can achieve very high-quality speech representation, but subsequent fine-tuning is required to prepare for a specific speech task. In addition, in some embodiments, the speech representation model 304 may be an unsupervised model implemented by using clustering, to generate the speech representation 306 of the source-language audio 304, and the speech representation model 304 may be fine-tuned and trained with a speech translation model 310 to achieve a better speech representation effect.

In some embodiments, the source-language audio 302 may be in English and needs to be translated into a Chinese text. In this case, the prompt content 308 may be “Please translate the source-language audio into a Chinese text” or “Translate into a Chinese text”. It should be noted that the translation of the English audio into the Chinese text is for illustrative purposes only, and the embodiments of the present disclosure may convert any trained source-language audio into a target text. For example, the source-language audio may be an unwritten language, that is, a language without a written form. In addition, the prompt content is also for illustrative purposes, and the present disclosure does not limit the specific form of the prompt content. Then, a translation text 312 corresponding to the source-language audio 302 may be generated by inputting the speech representation 306 and the prompt content 308 into the speech translation model 310. For example, the source-language audio 302 may be in English, and the prompt content 308 may be “Please translate the source-language audio into a Chinese text”. In this case, the corresponding translation text 312 may be a Chinese text. In some embodiments, the speech translation model 312 may be a decoder-only architecture model. Compared with an encoder-decoder architecture, a decoder-only architecture has better zero-shot learning capabilities, is more suitable for large-corpus self-supervised learning, and has better training efficiency, which can reduce the cost of engineering implementation.

In some embodiments, when generating the translation text 312, a chain-of-thought reasoning technology may be used for generation. By using the chain-of-thought reasoning technology, the effect of speech translation is better. For example, the source-language audio 302 may be in English and needs to be translated into a Chinese text. In this case, the prompt content 308 may be “Please transcribe the source-language audio and then translate it into Chinese”. Then, the speech representation 306 and the prompt content 308 are inputted into the speech translation model 310, to generate a transcribed text 314 and a translation text 312 corresponding to the source-language audio 302. The transcribed text is a corresponding source-language text obtained by converting the source-language audio. For example, the speech translation model 310 first transcribes the source-language audio 302 in the English form to generate the corresponding transcribed text 314 in the English form, and then generates the translation text 312 in the Chinese form based on the transcribed text 314. It should be understood that although the transcribed text and the translation text are generated here, the speech translation model of the embodiments of the present disclosure is still an end-to-end model. The transcribed text and the translation text are generated simultaneously here, and there is no cascaded transcription and translation tasks. Therefore, by using the chain-of-thought reasoning technology, the transcribed text may be generated first, and the translation text is generated after the transcribed text, so that there is more effective information in the source language to help the generation of the translation, improving the accuracy, readability, etc. of speech translation.

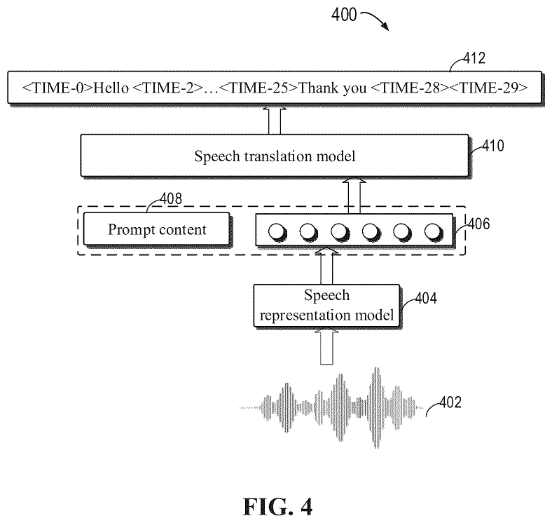

FIG. 4 is a schematic diagram of a process 400 for processing a long audio according to an embodiment of the present disclosure. At 402, an audio segment of the first 30 seconds of the source-language audio 402 may be extracted, where the source-language audio 402 is a long audio of unlimited length. Then, a speech representation 406 is generated by using a speech representation model 404, and then a time-stamped translation text 412 is generated by using a speech translation model 410 in combination with prompt content 408. For example, as shown in FIG. 4, the time-stamped translation text 412 may be “<time-0>Hello<time-2> . . . <time-25>Thank you<time-28><time-29>”, where <time-0> to <time-29> and the like are timestamp marks, and the time of sentence breaking is aligned to the nearest 20 ms. <time-0>Hello<time-2> may indicate that the content from 0 second to the 40th ms (20 ms*2) is “Hello”.

As described above, the audio segment of the first 30 seconds of the source-language audio 402 may be processed. Then, the audio segment of the first 30 seconds of the source-language audio 402 is discarded based on the timestamp of the end mark, and the next 30-second audio segment is extracted. This process is repeated until all the audio is processed. Therefore, for the source-language audio of unlimited length, end-to-end speech translation may be performed through the embodiments of the present disclosure, and the timestamp information corresponding to the text is given in the translation result.

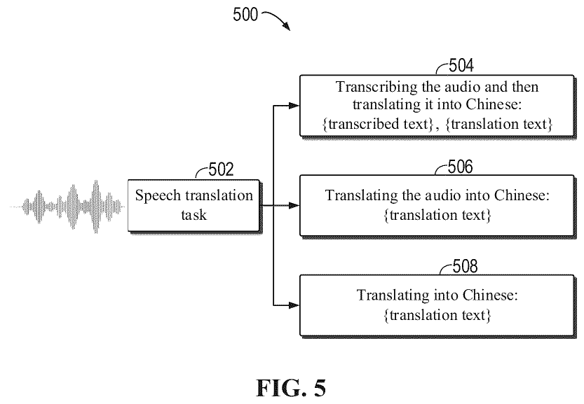

FIG. 5 is a schematic diagram of a process 500 for fine-tuning a speech translation model according to an embodiment of the present disclosure. As described above, the speech translation model may be a decoder-only architecture model, which may be pre-trained by using a large-scale document-level multilingual document, and the speech representation model may also be a pre-trained model. In some embodiments, when the speech translation model is fine-tuned, the speech representation model may be fine-tuned together, that is, the parameters of the speech representation model are adjusted accordingly. In some embodiments, when the speech translation model is fine-tuned, the speech representation model is not fine-tuned, that is, the parameters of the speech representation model do not change.

In some embodiments, the speech translation model may be fine-tuned by using a speech translation task 502. Specifically, the fine-tuning process may be performed by using English-to-Chinese speech translation. For example, at 504, the speech translation model may be fine-tuned by using “Transcribe and then translate the audio into Chinese: {transcribed text}, {translation text}”, where “{ }” indicates an actual transcribed text or translation text. Although the speech translation task is performed, the speech translation model is still prompted to perform transcription first to generate the transcribed text, and then perform translation to generate the translation text. Such fine-tuning may be referred to as chain-of-thought fine-tuning, because transcribing first and then translating are in line with the human's way of thinking, and can further improve the reasoning capability. In addition, the speech translation model may also be fine-tuned by using “Translate the audio into Chinese: {translation text}” shown at 506. In some embodiments, the speech translation model may also be fine-tuned by using “Translate into Chinese: {translation text}”.

In addition, in some embodiments, the fine-tuning process may be performed by using Chinese-to-English speech translation. For example, the speech translation model may be fine-tuned by using “Transcribe and then translate the audio into English: {transcribed text}, {translation text}”, “Translate the audio into English: {translation text}”, or “Translate into English: {translation text}”. In the embodiments of the present disclosure, the speech translation model may also be fine-tuned by using other languages, which is not limited in the present disclosure.

In addition, in some embodiments, the speech translation model may also be fine-tuned by using a text translation task. For example, for a Chinese-to-English text translation task, the prompt content may be “Please translate {a source-language text} into English: {translation text}”; or for a Chinese-to-English text translation task, the prompt content may be “Please translate {a source-language text} into Chinese: {translation text}”, where {a source-language text} and {translation text} are actual training texts.

In addition, in some embodiments, the fine-tuning process may be performed by using a speech recognition task. For example, for a Chinese speech recognition task, the prompt content may be “Transcribe the speech into Chinese: {transcribed text}”; for an English speech recognition task, the prompt content may be “Transcribe the speech into English: {transcribed text}”; for a Chinese mixed speech recognition task, the prompt content may be “Transcribe the speech into text: {transcribed text}”, and the like.

In addition, in some embodiments, the speech translation model may be fine-tuned by using a time-stamped speech recognition task. For example, the prompt content may be “Please transcribe the audio over time: {time-stamped transcribed text}”, and the time-stamped transcribed text may be “<time-0>Hello, <time-2><time-3>world<time-10>”.

In addition, in some embodiments, the speech translation model may be fine-tuned by using a time-stamped speech translation task. For example, the prompt content may be “Please translate the audio into Chinese over time: {time-stamped translation text}”, and the time-stamped translation text may be “<time-0>Hello, <time-2><time-3>world<time-10>”.

Therefore, the speech translation model is fine-tuned by using the multitask training method, so that the pre-trained speech translation model can achieve efficient transfer learning, which can improve the model effect, and greatly reduce the model training time and computing cost. In addition, the speech translation model may learn speech recognition, text translation, and speech translation patterns in a plurality of tasks, thereby improving various indicators of the speech translation model and the effect of the speech translation task.

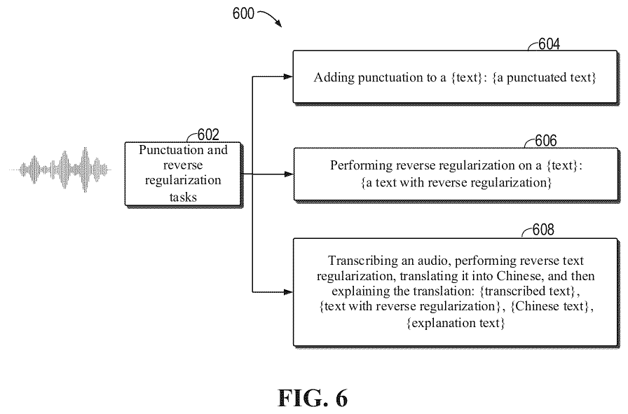

FIG. 6 is a schematic diagram of another process 600 for fine-tuning the speech translation model according to an embodiment of the present disclosure. At 602, a model may be fine-tuned by using a punctuation and reverse regularization task. At 604, the prompt content may be “Add punctuation to {a text}: {a punctuated text}”, for example, the prompt content is to add punctuation to {I think that when some people see a sign that says “No swimming”, they will let a child go into water with a shovel and bucket}: {I think that when some people see a sign that says “No swimming”, they will let a child go into water with a shovel and bucket}. Therefore, the speech translation task is fine-tuned by using the punctuation task, which can improve the capability of the speech translation model to correctly add punctuation when generating the translation text, improve fluency and readability of the translation text, and improve user experience when the user sees the translation.

In addition, at 604, the prompt content may be “Perform reverse regularization on {a text}: {a text with reverse regularization}”, to fine-tune the speech translation model. The reverse regularization here refers to that when a speech is converted into a text, objects such as numbers, amounts, dates, and addresses are displayed in a standardized format to conform to reading habits. For example, an original speech text is “20 percent”, and after reverse regularization, the text is “20%”; an original speech text is “one thousand six hundred and eighty yuan”, and after reverse regularization, the text is “1680 yuan”; an original speech text is “May 11th”, and after reverse regularization, the text is “May 11th”; an original speech text is “Please dial 110”, and after reverse regularization, the text is “Please dial 110”. Therefore, the speech translation task is fine-tuned by using the reverse regularization task, which can improve the capability of the speech translation model to convert numbers in the text form when generating the translation text, improve fluency and readability of the translation text, and improve user experience when the user sees the translation.

In addition, at 606, the prompt content may be “Transcribe the audio, perform reverse text regularization, translate it into Chinese, and then explain the translation: {transcribed text}, {text with reverse regularization}, {Chinese text}, {explanation text}”, to fine-tune the speech translation model by using a chain-of-thought prompt. In addition, the explanation text here is an explanation for the source-language text. The speech translation model is fine-tuned by using the explanation text, which can improve the effect of the speech model. For example, the source-language audio is an English audio; the transcribed text is “we are going to talk about a john dickerson proposed idea john frame it up for us”; the text with reverse regularization is “We're going to talk about a John Dickerson proposed idea. John, frame it up for us”; the translation text is “ [symbol] [symbol] [symbol] ”; and the explanation text is “-John Dickerson: This is a person's name. Be careful not to mistake it for a phrase; -frame it up: This is an oral expression, which means “frame it up for us”. Therefore, the explanation text adds additional information to the model to help the model understand some specific content in the audio and the text, so as to improve the reasoning capability of the model and the translation effect of the speech translation model.

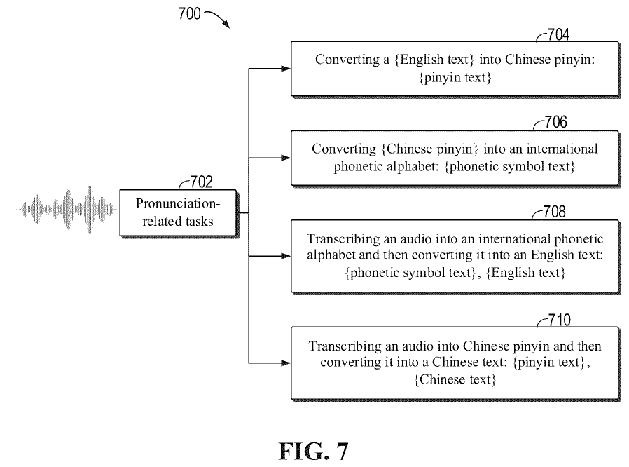

FIG. 7 is a schematic diagram of still another process 700 for fine-tuning the speech translation model according to an embodiment of the present disclosure. At 702, the speech translation model may be fine-tuned by using a pronunciation-related task. The pronunciation task here refers to fine-tuning the speech translation model by using conversion between an English audio, an English text, an international phonetic alphabet, Chinese pinyin, and a Chinese text. At 704, the prompt content may be “Convert {an English text} into Chinese pinyin: {pinyin text}”. At 706, the prompt content may be “Convert {Chinese pinyin} into an international phonetic alphabet: {phonetic symbol text}”, to fine-tune the speech translation model. At 708, the prompt content may be “Transcribe the audio into an international phonetic alphabet and then convert it into an English text: {phonetic symbol text}, {English text}”, to fine-tune the speech translation model by using a chain-of-thought prompt. At 710, the prompt content may be “Transcribe the audio into Chinese pinyin and then convert it into a Chinese text: {pinyin text}, {Chinese text}”, to fine-tune the speech translation model. Therefore, the speech translation model is fine-tuned by using the pronunciation-related task, which can improve the indicators of the speech translation model and the effect of the speech translation task.

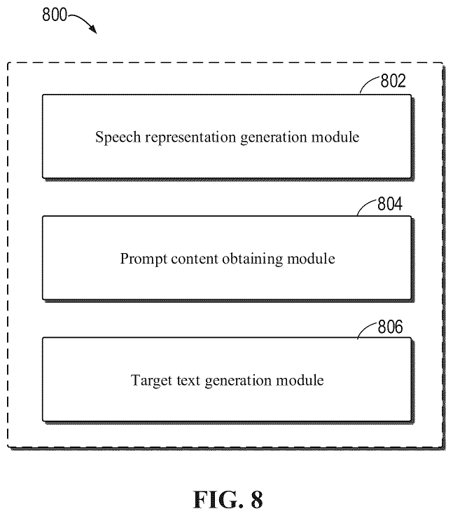

FIG. 8 shows a block diagram of a speech translation apparatus 800 according to some embodiments of the present disclosure. As shown in FIG. 8, the apparatus 800 includes a speech representation generation module 802 configured to generate a speech representation corresponding to a source-language audio based on the audio. The apparatus 800 also includes a prompt content obtaining module 804 configured to obtain prompt content related to a target language. In addition, the apparatus 800 also includes a target text generation module 806 configured to generate a target-language text corresponding to the audio based on the speech representation and the prompt content.

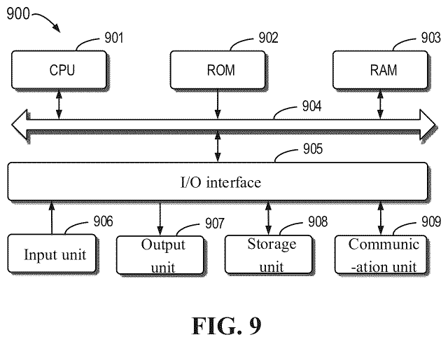

FIG. 9 shows a block diagram of an electronic device 900 according to some embodiments of the present disclosure. FIG. 9 shows a block diagram of an electronic device 900 according to some embodiments of the present disclosure, and the device 900 may be the device or apparatus described in the embodiments of the present disclosure. As shown in FIG. 9, the device 900 includes a central processing unit (CPU) and/or a graphics processing unit (GPU) 901 that may perform various appropriate actions and processing in accordance with a computer program instruction stored in a read-only memory (ROM) 902 or a computer program instruction loaded from a storage unit 908 into a random access memory (RAM) 903. The RAM 903 may further store various programs and data required for the operation of the device 900. The CPU/GPU 901, the ROM 902, and the RAM 903 are connected to each other through a bus 904. An input/output (I/O) interface 905 is also connected to the bus 904. Although not shown in FIG. 9, the device 900 may further include a coprocessor.

A plurality of components in the device 900 are connected to the I/O interface 905, including: an input unit 906, such as a keyboard, a mouse, etc.; an output unit 907, such as various types of displays, speakers, etc.; the storage unit 908, such as a disk, an optical disc, etc.; and a communication unit 909, such as a network card, a modem, a wireless communication transceiver, etc. The communication unit 909 allows the device 900 to exchange information/data with other devices over a computer network such as the Internet and/or various telecommunication networks.

Each of the methods or processes described above may be performed by the CPU/GPU 901. For example, in some embodiments, the method may be implemented as a computer software program tangibly contained in a machine-readable medium, such as the storage unit 908. In some embodiments, all or some of the computer program may be loaded and/or installed onto the device 900 via the ROM 902 and/or the communication unit 909. When the computer program is loaded into the RAM 903 and executed by the CPU/GPU 901, one or more steps or actions in the methods or processes described above may be performed.

In some embodiments, the methods and processes described above may be implemented as a computer program product. The computer program product may include a computer-readable storage medium having computer-readable program instructions loaded thereon for performing various aspects of the present disclosure.

The computer-readable storage medium may be a tangible device that can retain and store instructions used by an instruction-executing device. The computer-readable storage medium may be, for example, but not limited to, an electrical storage device, a magnetic storage device, an optical storage device, an electromagnetic storage device, a semiconductor storage device, or any suitable combination thereof. A more specific example (a non-exhaustive list) of the computer-readable storage medium includes: a portable computer disk, a hard disk, a random access memory (RAM), a read-only memory (ROM), an erasable programmable read-only memory (EPROM or flash memory), a static random access memory (SRAM), a portable compact disk read-only memory (CD-ROM), a digital versatile disk (DVD), a memory stick, a floppy disk, a mechanical encoding device, for example, a punch card or a groove having instructions stored thereon, or an inner protrusion structure, and any suitable combination of the foregoing. The computer-readable storage medium used herein is not interpreted as a transitory signal per se, such as radio waves or other freely propagating electromagnetic waves, electromagnetic waves propagating through a waveguide or other transmission medium (for example, an optical pulse passing through a fiber optic cable), or an electrical signal transmitted through an electric wire.

The computer-readable program instructions described herein may be downloaded from a computer-readable storage medium to various computing/processing devices, or downloaded from an external computer or external storage device over a network, such as the Internet, a local area network, a wide area network, and/or a wireless network. The network may include copper transmission cables, optical fiber transmission, wireless transmission, routers, firewalls, switches, gateway computers, and/or edge servers. The network adapter or network interface in each computing/processing device receives the computer-readable program instructions from the network and forwards the computer-readable program instructions for storage in a computer-readable storage medium in the various computing/processing devices.

The computer program instructions for performing the operations of the present disclosure may be assembly instructions, instruction set architecture (ISA) instructions, machine instructions, machine-related instructions, microcode, firmware instructions, state setting data, or source code or object code written in one or more programming languages, where the programming languages include an object-oriented programming language, and conventional procedural programming languages. The computer-readable program instructions may be completely executed on a computer of a user, partially executed on a computer of a user, executed as an independent software package, partially executed on a computer of a user and partially executed on a remote computer, or completely executed on a remote computer or server. In the case involving the remote computer, the remote computer may be connected to the computer of the user over any type of network, including a local area network (LAN) or a wide area network (WAN), or may be connected to an external computer (for example, connected over the Internet using an Internet service provider). In some embodiments, an electronic circuit, for example, a programmable logic circuit, a field programmable gate array (FPGA), or a programmable logic array (PLA), is personalized by using the state information of the computer-readable program instructions, and the electronic circuit may execute the computer-readable program instructions, to implement various aspects of the present disclosure.

These computer-readable program instructions may be provided to a processing unit of a general-purpose computer, a special-purpose computer, or another programmable data processing apparatus to produce a machine, such that the instructions, when executed by the processing unit of the computer or another programmable data processing apparatus, create means for implementing the functions/acts specified in one or more blocks in the flowcharts and/or block diagrams. These computer-readable program instructions may alternatively be stored in a computer-readable storage medium. These instructions enable a computer, a programmable data processing apparatus, and/or another device to work in a specific manner. Therefore, the computer-readable medium storing the instructions includes a product which includes instructions for implementing various aspects of the functions/acts specified in one or more blocks in the flowcharts and/or block diagrams.

The computer-readable program instructions may also be loaded onto a computer, another programmable data processing apparatus, or another device, so that a series of operation steps are performed on the computer, another programmable data processing apparatus, or another device, to generate a computer-implemented process. Therefore, the instructions executed on the computer, another programmable data processing apparatus, or another device implement the functions/acts specified in one or more blocks in the flowcharts and/or block diagrams.

The flowcharts and block diagrams in the accompanying drawings illustrate the possibly implemented architecture, functions, and operations of the apparatus, methods, and computer program products according to a plurality of embodiments of the present disclosure. In this regard, each block in the flowchart or block diagram may represent a module, program segment, or part of an instruction, and the module, program segment, or part of an instruction contains one or more executable instructions for implementing the specified logical functions. In some alternative implementations, the functions marked in the blocks may also occur in an order different from that marked in the accompanying drawings. For example, two consecutive blocks may actually be performed substantially in parallel, or they may sometimes be performed in the reverse order, depending on the functions involved. It should also be noted that each block in the block diagram and/or the flowchart, and a combination of the blocks in the block diagram and/or the flowchart may be implemented by a dedicated hardware-based system that executes specified functions or acts, or may be implemented by a combination of dedicated hardware and computer instructions.

The various embodiments of the present disclosure have been described above. The foregoing descriptions are exemplary, not exhaustive, and are not limited to the disclosed embodiments. Many modifications and changes are obvious to a person of ordinary skill in the art without departing from the scope and spirit of the described embodiments. The selection of terms used herein is intended to best explain the principles, practical applications, or technical improvements in the market of the embodiments, or to enable a person of ordinary skill in the art to understand the embodiments disclosed herein.

The following lists some example implementations of the present disclosure.

Example 1. A speech translation method, comprising:
generating a speech representation corresponding to a source-language audio based on the audio;
obtaining prompt content related to a target language; and
generating a target-language text corresponding to the audio based on the speech representation and the prompt content.

Example 2. The method according to Example 1, wherein obtaining the prompt content related to the target language comprises:
obtaining first prompt content, wherein the first prompt content is related to a transcription task; and
obtaining second prompt content, wherein the second prompt content is related to a translation task and the target language.

Example 3. The method according to any one of Examples 1 to 2, wherein generating the target-language text corresponding to the audio comprises:
generating the target-language text based on the speech representation, the first prompt content, and the second prompt content.

Example 4. The method according to any one of Examples 1 to 3, wherein generating the target-language text corresponding to the audio comprises:
determining an audio length of the source-language audio;
in response to the audio length of the audio being greater than a predetermined length, extracting a first audio segment of the predetermined length from a head of the audio; and
generating a first target-language text segment corresponding to the first audio segment based on the first audio segment.

Example 5. The method according to any one of Examples 1 to 4, further comprising:
discarding the first audio segment of the predetermined length from the audio;
in response to determining that the audio length of the audio is greater than the predetermined length, extracting a second audio segment of the predetermined length from the head of the audio;
generating a second target-language text segment corresponding to the second audio segment based on the second audio segment; and
generating the target-language text by combining the first target-language text segment and the second target-language text segment.

Example 6. The method according to any one of Examples 1 to 5, wherein the target-language text segment comprises a speech recognition text, a timestamp corresponding to the speech recognition text, and a speech translation text.

Example 7. The method according to any one of Examples 1 to 6, wherein discarding the first audio segment of the predetermined length from the audio comprises:
determining an end mark based on the timestamp; and
discarding the first audio segment of the predetermined length from the audio based on the end mark.

Example 8. The method according to any one of Examples 1 to 7, wherein the target-language text is generated by using a speech translation model, and the speech translation model is pre-trained by using a document-level multilingual document and adjusted by using a multitask.

Example 9. The method according to any one of Examples 1 to 8, wherein adjusting the speech translation model by using the multitask comprises:
obtaining a source-language audio and a corresponding target-language text;
obtaining corresponding prompt content based on a speech translation task; and
adjusting the speech translation model based on the corresponding prompt content, the source-language audio, and the corresponding target-language text.

Example 10. The method according to any one of Examples 1 to 9, wherein the corresponding prompt content comprises a transcription prompt content and a translation prompt content, and adjusting the speech translation model comprises:

adjusting the speech translation model based on the transcription prompt content, the translation prompt content, the source-language audio, and the corresponding target-language text.

Example 11. The method according to any one of Examples 1 to 10, wherein adjusting the speech translation model by using the multitask comprises:
obtaining a source-language audio and a corresponding punctuated source-language text;
obtaining corresponding prompt content based on a punctuation speech transcription task; and
adjusting the speech translation model based on the corresponding prompt content, the source-language audio, and the corresponding punctuated source-language text.

Example 12. The method according to any one of Examples 1 to 11, wherein adjusting the speech translation model by using the multitask comprises:
adjusting the speech translation model by using a source-language text, a target-language text, and an explanation for the target-language text.

Example 13. The method according to any one of Examples 1 to 12, wherein adjusting the speech translation model by using the multitask comprises:
obtaining a source-language text and a corresponding source-language text with reverse regularization;
obtaining corresponding prompt content based on a reverse regularization task; and
adjusting the speech translation model based on the corresponding prompt content, the source-language text, and the corresponding source-language text with reverse regularization.

Example 14. The method according to any one of Examples 1 to 13, wherein adjusting the speech translation model by using the multitask comprises:
adjusting the speech translation model by using an English audio, an English text, an international phonetic alphabet, Chinese pinyin, and a Chinese text.

Example 15. A speech translation apparatus, comprising:
a speech representation generation module configured to generate a speech representation corresponding to a source-language audio based on the audio;
a prompt content obtaining module configured to obtain prompt content related to a target language; and
a target text generation module configured to generate a target-language text corresponding to the audio based on the speech representation and the prompt content.

Example 16. The apparatus according to Example 15, wherein obtaining the prompt content related to the target language comprises:
a first prompt content obtaining module configured to obtain first prompt content, wherein the first prompt content is related to a transcription task; and
a second prompt content obtaining module configured to obtain second prompt content, wherein the second prompt content is related to a translation task and the target language.

Example 17. The apparatus according to any one of Examples 15 to 16, wherein generating the target-language text corresponding to the audio comprises:
a second target text generation module configured to generate the target-language text based on the speech representation, the first prompt content, and the second prompt content.

Example 18. The apparatus according to any one of Examples 15 to 17, wherein generating the target-language text corresponding to the audio comprises:
an audio length determination module configured to determine an audio length of the source-language audio;
an audio segment extraction module configured to extract, from a head of the audio, a first audio segment of a predetermined length in response to the audio length of the audio being greater than the predetermined length; and
a target text segment generation module configured to generate a first target-language text segment corresponding to the first audio segment based on the first audio segment.

Example 19. The apparatus according to any one of Examples 15 to 18, further comprising:
an audio segment discarding module configured to discard the first audio segment of the predetermined length from the audio;
a second audio segment extraction module configured to extract, from the head of the audio, a second audio segment of the predetermined length in response to determining that the audio length of the audio is greater than the predetermined length;
a second text segment generation module configured to generate a second target-language text segment corresponding to the second audio segment based on the second audio segment; and
a third target text generation module configured to generate the target-language text by combining the first target-language text segment and the second target-language text segment.

Example 20. The apparatus according to any one of Examples 15 to 19, wherein the target-language text segment comprises a speech recognition text, a timestamp corresponding to the speech recognition text, and a speech translation text.

Example 21. The apparatus according to any one of Examples 15 to 20, wherein discarding the first audio segment of the predetermined length from the audio comprises:

an end mark determination module configured to determine an end mark based on the timestamp; and
a second audio segment discarding module configured to discard the first audio segment of the predetermined length from the audio based on the end mark.

Example 22. The apparatus according to any one of Examples 15 to 21, wherein the target-language text is generated by using a speech translation model, and the speech translation model is pre-trained by using a document-level multilingual document and adjusted by using a multitask.

Example 23. The apparatus according to any one of Examples 15 to 22, wherein adjusting the speech translation model by using the multitask comprises:
a first data obtaining module configured to obtain a source-language audio and a corresponding target-language text;
a first prompt obtaining module configured to obtain corresponding prompt content based on a speech translation task; and
a first model adjustment module configured to adjust the speech translation model based on the corresponding prompt content, the source-language audio, and the corresponding target-language text.

Example 24. The apparatus according to any one of Examples 15 to 23, wherein the corresponding prompt content comprises a transcription prompt content and a translation prompt content, and adjusting the speech translation model comprises:
a second model adjustment module configured to adjust the speech translation model based on the transcription prompt content, the translation prompt content, the source-language audio, and the corresponding target-language text.

Example 25. The apparatus according to any one of Examples 15 to 24, wherein adjusting the speech translation model by using the multitask comprises:
a third data obtaining module configured to obtain a source-language audio and a corresponding punctuated source-language text;
a third prompt obtaining module configured to obtain corresponding prompt content based on a punctuation speech transcription task; and
a third model adjustment module configured to adjust the speech translation model based on the corresponding prompt content, the source-language audio, and the corresponding punctuated source-language text.

Example 26. The apparatus according to any one of Examples 15 to 25, wherein adjusting the speech translation model by using the multitask comprises:
a fourth model adjustment module configured to adjust the speech translation model by using a source-language text, a target-language text, and an explanation for the target-language text.

Example 27. The apparatus according to any one of Examples 15 to 26, wherein adjusting the speech translation model by using the multitask comprises:
a fifth data obtaining module configured to obtain a source-language text and a corresponding source-language text with reverse regularization;
a fifth prompt obtaining module configured to obtain corresponding prompt content based on a reverse regularization task; and
a fifth model adjustment module configured to adjust the speech translation model based on the corresponding prompt content, the source-language text, and the corresponding source-language text with reverse regularization.

Example 28. The apparatus according to any one of Examples 15 to 27, wherein adjusting the speech translation model by using the multitask comprises:
a sixth model adjustment module configured to adjust the speech translation model by using an English audio, an English text, an international phonetic alphabet, Chinese pinyin, and a Chinese text.

Example 29. An electronic device, comprising:
a processor; and
a memory coupled with the processor, the memory having instructions stored therein, the instructions, when executed by the processor, causing the electronic device to perform actions, the actions comprising:
generating a speech representation corresponding to a source-language audio based on the audio;
obtaining prompt content related to a target language; and
generating a target-language text corresponding to the audio based on the speech representation and the prompt content.

Example 30. The device according to Example 29, wherein obtaining the prompt content related to the target language comprises:
obtaining first prompt content, wherein the first prompt content is related to a transcription task; and
obtaining second prompt content, wherein the second prompt content is related to a translation task and the target language.

Example 31. The device according to any one of Examples 29 to 30, wherein generating the target-language text corresponding to the audio comprises:
generating the target-language text based on the speech representation, the first prompt content, and the second prompt content.

Example 32. The device according to any one of Examples 29 to 31, wherein generating the target-language text corresponding to the audio comprises:
determining an audio length of the source-language audio;
in response to the audio length of the audio being greater than a predetermined length, extracting a first audio segment of the predetermined length from a head of the audio; and
generating a first target-language text segment corresponding to the first audio segment based on the first audio segment.

Example 33. The device according to any one of Examples 29 to 32, the actions further comprising:
discarding the first audio segment of the predetermined length from the audio;
in response to determining that the audio length of the audio is greater than the predetermined length, extracting a second audio segment of the predetermined length from the head of the audio;
generating a second target-language text segment corresponding to the second audio segment based on the second audio segment; and
generating the target-language text by combining the first target-language text segment and the second target-language text segment.

Example 34. The device according to any one of Examples 29 to 33, wherein the target-language text segment comprises a speech recognition text, a timestamp corresponding to the speech recognition text, and a speech translation text.

Example 35. The device according to any one of Examples 29 to 34, wherein discarding the first audio segment of the predetermined length from the audio comprises:
determining an end mark based on the timestamp; and
discarding the first audio segment of the predetermined length from the audio based on the end mark.

Example 36. The device according to any one of Examples 29 to 35, wherein the target-language text is generated by using a speech translation model, and the speech translation model is pre-trained by using a document-level multilingual document and adjusted by using a multitask.

Example 37. The device according to any one of Examples 29 to 36, wherein adjusting the speech translation model by using the multitask comprises:
obtaining a source-language audio and a corresponding target-language text;
obtaining corresponding prompt content based on a speech translation task; and
adjusting the speech translation model based on the corresponding prompt content, the source-language audio, and the corresponding target-language text.

Example 38. The device according to any one of Examples 29 to 37, wherein the corresponding prompt content comprises a transcription prompt content and a translation prompt content, and adjusting the speech translation model comprises:
adjusting the speech translation model based on the transcription prompt content, the translation prompt content, the source-language audio, and the corresponding target-language text.

Example 39. The device according to any one of Examples 29 to 38, wherein adjusting the speech translation model by using the multitask comprises:
obtaining a source-language audio and a corresponding punctuated source-language text;
obtaining corresponding prompt content based on a punctuation speech transcription task; and
adjusting the speech translation model based on the corresponding prompt content, the source-language audio, and the corresponding punctuated source-language text.

Example 40. The device according to any one of Examples 29 to 39, wherein adjusting the speech translation model by using the multitask comprises:
adjusting the speech translation model by using a source-language text, a target-language text, and an explanation for the target-language text.

Example 41. The device according to any one of Examples 29 to 40, wherein adjusting the speech translation model by using the multitask comprises:
obtaining a source-language text and a corresponding source-language text with reverse regularization;
obtaining corresponding prompt content based on a reverse regularization task; and
adjusting the speech translation model based on the corresponding prompt content, the source-language text, and the corresponding source-language text with reverse regularization.

Example 42. The device according to any one of Examples 29 to 41, wherein adjusting the speech translation model by using the multitask comprises:
adjusting the speech translation model by using an English audio, an English text, an international phonetic alphabet, Chinese pinyin, and a Chinese text.

Example 43. A computer-readable storage medium having one or more computer instructions stored thereon, wherein the one or more computer instructions are executed by a processor to implement the method according to any one of Examples 1 to 14.

Example 44. A computer program product, wherein the computer program product is tangibly stored on a computer-readable medium and includes computer-executable instructions, and the computer-executable instructions, when executed by a device, cause the device to perform the method according to any one of Examples 1 to 14.

Although the subject matter has been described in a language specific to structural features and/or logical actions of the method, it should be understood that the subject matter specified in the appended claims is not necessarily limited to the specific features or actions described above. In contrast, the specific features and actions described above are merely exemplary forms of implementing the claims.

I/We claim:

1. A speech translation method, comprising:
generating a speech representation corresponding to a source-language audio based on the audio;
obtaining prompt content related to a target language; and
generating a target-language text corresponding to the audio based on the speech representation and the prompt content.

2. The method of claim 1, wherein obtaining the prompt content related to the target language comprises:
obtaining first prompt content, wherein the first prompt content is related to a transcription task; and
obtaining second prompt content, wherein the second prompt content is related to a translation task and the target language.

3. The method of claim 2, wherein generating the target-language text corresponding to the audio comprises:
generating the target-language text based on the speech representation, the first prompt content, and the second prompt content.

4. The method of claim 1, wherein generating the target-language text corresponding to the audio comprises:
determining an audio length of the source-language audio;
in response to the audio length of the audio being greater than a predetermined length, extracting, from a head of the audio, a first audio segment having the predetermined length; and
generating a first target-language text segment corresponding to the first audio segment based on the first audio segment.

5. The method of claim 4, further comprising:
discarding, from the audio, the first audio segment having the predetermined length;
in response to determining that the audio length of the audio is greater than a predetermined length, extracting, from the head of the audio, a second audio segment having the predetermined length;
generating a second target-language text segment corresponding to the second audio segment based on the second audio segment; and
generating the target-language text by combining the first target-language text segment and the second target-language text segment.

6. The method of claim 5, wherein the target-language text segment comprises a speech recognition text, a timestamp corresponding to the speech recognition text, and a speech translation text.

7. The method of claim 6, wherein discarding, from the audio, the first audio segment having the predetermined length comprises:
determining an end mark based on the timestamp; and
discarding, from the audio, the first audio segment having the predetermined length based on the end mark.

8. The method of claim 1, wherein the target-language text is generated via a speech translation model, and the speech translation model is pre-trained by using a document-level multilingual document and adjusted by using a multitask.

9. The method of claim 8, wherein adjusting the speech translation model by using the multitask comprises:
obtaining a source-language audio and a corresponding target-language text;
obtaining corresponding prompt content based on a speech translation task; and
adjusting the speech translation model based on the corresponding prompt content, the source-language audio, and the corresponding target-language text.

10. The method of claim 9, wherein the corresponding prompt content comprises transcription prompt content and translation prompt content, and adjusting the speech translation model comprises:
adjusting the speech translation model based on the transcription prompt content, the translation prompt content, the source-language audio, and the corresponding target-language text.

11. The method of claim 8, wherein adjusting the speech translation model by using the multitask comprises:
obtaining a source-language audio and a corresponding punctuated source-language text;
obtaining corresponding prompt content based on a punctuated speech transcription task; and
adjusting the speech translation model based on the corresponding prompt content, the source-language audio, and the corresponding punctuated source-language text.

12. The method of claim 8, wherein adjusting the speech translation model by using the multitask comprises:
adjusting the speech translation model by using a source-language text, a target-language text, and an explanation for the target-language text.

13. The method of claim 8, wherein adjusting the speech translation model by using the multitask comprises:
obtaining a source-language text and a corresponding source-language text with reverse regularization;
obtaining corresponding prompt content based on a reverse regularization task; and adjusting the speech translation model based on the corresponding prompt content, the source-language text, and the corresponding source-language text with reverse regularization.

14. The method of claim 8, wherein adjusting the speech translation model by using the multitask comprises:
adjusting the speech translation model by using an English audio, an English text, an international phonetic alphabet, Chinese pinyin, and a Chinese text.

15. An electronic device, comprising:
a processor; and
a memory coupled with the processor, wherein the memory has stored therein instructions that, when executed by the processor, cause the electronic device to perform a speech translation method comprising:
generating a speech representation corresponding to a source-language audio based on the audio;
obtaining prompt content related to a target language; and
generating a target-language text corresponding to the audio based on the speech representation and the prompt content.

16. The electronic device of claim 15, wherein obtaining the prompt content related to the target language comprises:
obtaining first prompt content, wherein the first prompt content is related to a transcription task; and
obtaining second prompt content, wherein the second prompt content is related to a translation task and the target language.

17. The electronic device of claim 16, wherein generating the target-language text corresponding to the audio comprises:
generating the target-language text based on the speech representation, the first prompt content, and the second prompt content.

18. The electronic device of claim 15, wherein generating the target-language text corresponding to the audio comprises:
determining an audio length of the source-language audio;
in response to the audio length of the audio being greater than a predetermined length, extracting, from a head of the audio, a first audio segment having the predetermined length; and
generating a first target-language text segment corresponding to the first audio segment based on the first audio segment.

19. The electronic device of claim 18, wherein the method further comprises:
discarding, from the audio, the first audio segment having the predetermined length;
in response to determining that the audio length of the audio is greater than a predetermined length, extracting, from the head of the audio, a second audio segment having the predetermined length;
generating a second target-language text segment corresponding to the second audio segment based on the second audio segment; and
generating the target-language text by combining the first target-language text segment and the second target-language text segment.

20. A non-transitory computer-readable storage medium having stored thereon computer-executable instructions, wherein the computer-executable instructions, when executed by a processor, implement a speech translation method comprising:
generating a speech representation corresponding to a source-language audio based on the audio;
obtaining prompt content related to a target language; and
generating a target-language text corresponding to the audio based on the speech representation and the prompt content.
